(19) United States
(12) Patent Application Publication
(10) Pub. No.: US 2011/0132690 A1
(43) Pub. Date: Jun. 9, 2011

(54) Mechanical energy storage system

(76) Inventor: Philip T. Hanthorn, Sonora, CA (US)

(21) Appl. No.: 12/592,807

(22) Filed: Dec. 4, 2009

(51) Int. Cl. F03G 3/00; F03G 6/00

(52) U.S. Cl. 185/31

(57) ABSTRACT

This invention relates to a mechanical energy storage system, incorporating upper and lower reservoirs supported in a rigid frame. Metal balls are initially stored in the upper reservoir, a form of storage with potential energy that can be converted to kinetic energy. The balls are selectively released from the upper reservoir. The balls are then guided by a plurality of ramps, and said balls are then deposited in the lower reservoir. The invention further relates to renewable energy, such as solar energy, as a means of returning the balls from the lower to the upper reservoir. A further object is that the invention will continue to operate during those periods of time when solar energy is unavailable, without relying on backup power from battery packs or from power coming directly from a utility company.

### BACKGROUND OF THE INVENTION

Energy storage systems with water are well known throughout history. An example is the millpond functioning as a reservoir to operate a waterwheel. The construction of dams on rivers to operate a waterwheel is another example. These storage systems evolved into the modern hydroelectric facilities. Regionally, locations for these facilities are limited, and drought conditions and evaporation can reduce the capability of these storage systems.

With the development of the steam engine, pumping water into these storage systems increased their capability, but pumping water from a lower to an upper elevation did not solve the limited locations or the conditions of drought and evaporation.

The steam engine and other combustion engines are generally powered by fossil fuel. This form of fuel is not a renewable resource, and the burning of fossil fuel is the source of pollution.

These circumstances point to the need to develop other forms of energy storage.

Water and other fluids can store heat energy, and heat energy can be utilized to power a combustion engine. When these fluids are heated with renewable energy, the pollution from a combustion engine is circumvented. The disadvantage is that the second law of thermodynamics reduces the efficiency of these storage systems, in that some of the stored energy is dissipated into the environment. The dissipated energy cannot be applied to the operation of an engine.

Mechanical energy storage systems are known in the prior art. When these systems are powered by renewable forms of energy, such as solar and wind, the efficiency of these systems is increased, in that energy is not dissipated into the environment, and these storage systems circumvent the disadvantage of limited locations, drought and evaporation. These storage systems also circumvent the pollution generated by burning fossil fuel.

U.S. Pat. No. 4,337,622, Energy Storage, describes a mechanical storage system. This invention is solar powered. The solar energy is utilized to compress a spring, and potential energy is stored in the compressed spring. U.S. Pat. No. 3,678,685, Solar Energy Powered Heliotrope, describes a mechanical storage system. This invention is also solar powered, in that solar energy is converted to potential energy which is stored in a spring.

Flywheel technology has also been applied to this form of energy storage, in that renewable energy can be utilized to set the flywheel in motion. The renewable energy is converted to potential energy which is stored in the spinning flywheel.

Renewable energy does have a disadvantage. This form of energy is intermittent. For example, solar energy in many regions is only available for eight hours per day in the summer months, and for as few as five hours per day in the winter months. There are also regions where solar energy may not be available for many days consecutively, and in some regions for as long as a week.

To keep a machine in operation, the storage capacity must continue to supply energy during those periods of time when solar energy is unavailable. Flywheel and spring technology are not well suited to store sufficient energy to keep a machine in continuous operation during those periods of time when solar energy is unavailable. With spring technology in particular, an additional difficulty is that transferring the stored energy from a spring to perform useful work can be cumbersome. A detailed reading of U.S. Pat. Nos. 4,337,622 and 3,678,685 explains the challenge of transferring energy stored in a spring.

In order to keep machines powered by renewable energy in continuous operation, it has been necessary to incorporate a backup system of power. These backup systems often utilize battery packs for electric storage. Another backup system is to rely directly on energy generated by a utility company.

### SUMMARY OF THE PRESENT INVENTION

The present invention has a mechanical energy storage system that will keep the machine in continuous operation without a backup power system. This invention relates to a machine with stacked reservoirs supported on a rigid frame. The upper reservoir contains metal balls. This reservoir has sufficient angle to cause the metal balls to move in a downward direction. The metal balls are received in a container adjacent to the upper reservoir. The receiving container has sufficient angle to move the balls in a downward direction. A holding mechanism is positioned in the receiving container. The holding mechanism prevents the balls in the receiving container and in the upper reservoir from moving in a downward direction.

The holding mechanism also functions as a release mechanism. The release mechanism selects a single ball from the receiving container. The single ball moves from the receiving container onto a conduit. The conduit has sufficient angle to move the ball in a downward direction. The conduit directs the ball onto the upper platform. The upper platform is positioned below the receiving container and below the upper reservoir. The upper platform has sufficient angle to move the ball in a downward direction. The upper platform has a plurality of beveled ramps. The ramps have sufficient angle to move the ball in a downward direction. The ramps are sequentially spaced and positioned to move the ball from side to side on the upper platform. The ball moves in a downward direction, where it moves onto the lower platform. The lower platform has sufficient angle to move the ball in a downward direction. The lower platform is positioned below the upper platform. The lower platform has ramps sequentially spaced to move the ball from side to side on the platform. The ball moves in a downward direction, where the ball moves onto a conduit positioned at the lowest point on the lower platform.

The conduit has sufficient angle to move the ball in a downward direction. The ball moves onto another section of conduit. This section of conduit has sufficient angle and length to cause the ball to accelerate. The ball accelerates to increase the inertia of the ball. With increased acceleration and inertia, the ball makes contact with a lever at the end of the conduit. The ball is deposited in the lower reservoir after making contact with the lever. This lever makes contact with another lever positioned on the receiving container. The lever on the receiving container makes contact with the release mechanism. The release mechanism selects a single ball from the receiving container, and the sequence of movements just described is repeated.

The solar panel, the direct current motor and the conveyor to lift the metal balls from the lower to the upper reservoir are well represented in the prior art, and these forms of technology are well represented within the commercial market. As a result, the solar panel, the motor and the conveyor are not shown in the present invention. However, these types of technology are well suited to lift the metal balls from the lower to the upper reservoir.

The primary object of the present invention is to overcome the shortcomings of the energy storage systems in the prior art. These systems are not well suited to store energy for extended periods of time when renewable forms of energy are unavailable.

A further object of the present invention is to provide a system of storage that can comfortably surpass the extended periods of time when solar energy is unavailable.

A further object of the present invention is to provide a machine that is completely independent of a backup power supply.

A further object of the present invention is to convert solar energy to potential energy.

A further object of the present invention is to convert solar energy to potential energy without a loss of energy into the environment during the conversion process.

A further object of the present invention is to convert solar energy to stored potential energy.

A further object of the present invention is to convert the stored potential energy to kinetic energy.

A further object of the present invention is to utilize the kinetic energy as a power source to engage the mechanisms of the machine.

A further object of the present invention is to selectively control the stored potential energy.

A further object of the present invention is to provide a potential energy storage system that is environmentally benign.

A further object of the present invention is to provide a machine that is relatively inexpensive to construct and maintain.

### BRIEF DESCRIPTION OF THE DRAWINGS

FIG. 1 is a side view of the invention, incorporating views of the frame, the upper and lower reservoirs, the receiving container, the upper and lower conduits, the upper and lower platforms, the primary and secondary levers, the release lever, the hold-and-release mechanism, and the metal balls,

FIG. 2 is a top view of the upper platform, incorporating views of the beveled ramps, the receiving container, the upper conduit, the directional conduit, and the guide opening,

FIG. 3 is a top view of the lower platform, incorporating views of the beveled ramps, the lower conduit, and the directional conduit,

FIG. 4 is an overview of the hold-and-release mechanism, incorporating views of the release lever, the primary and secondary levers, the receiving container, and metal balls.

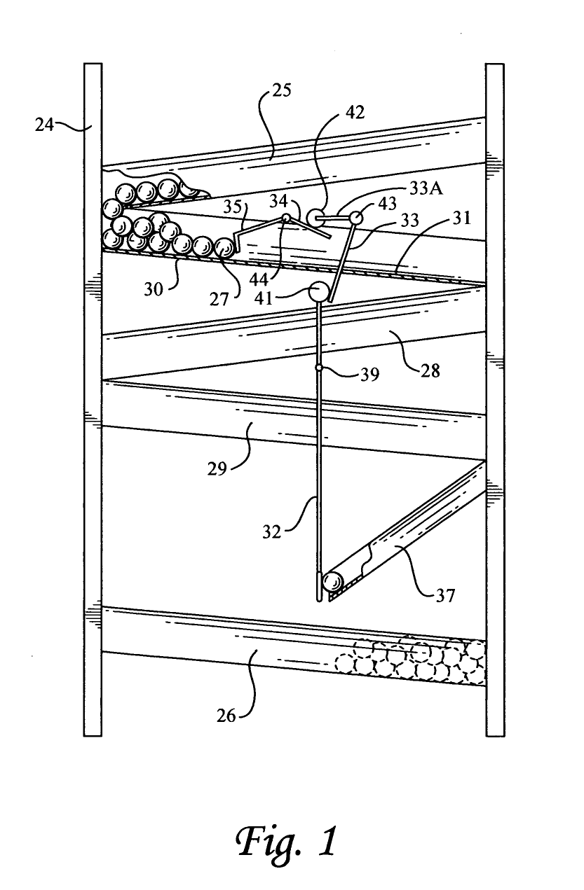

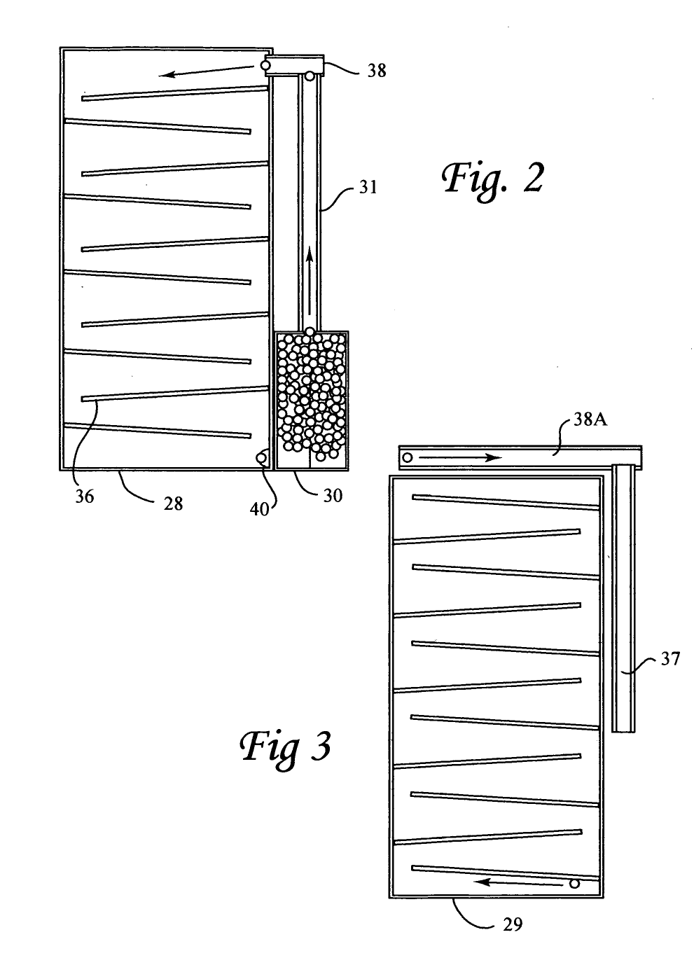

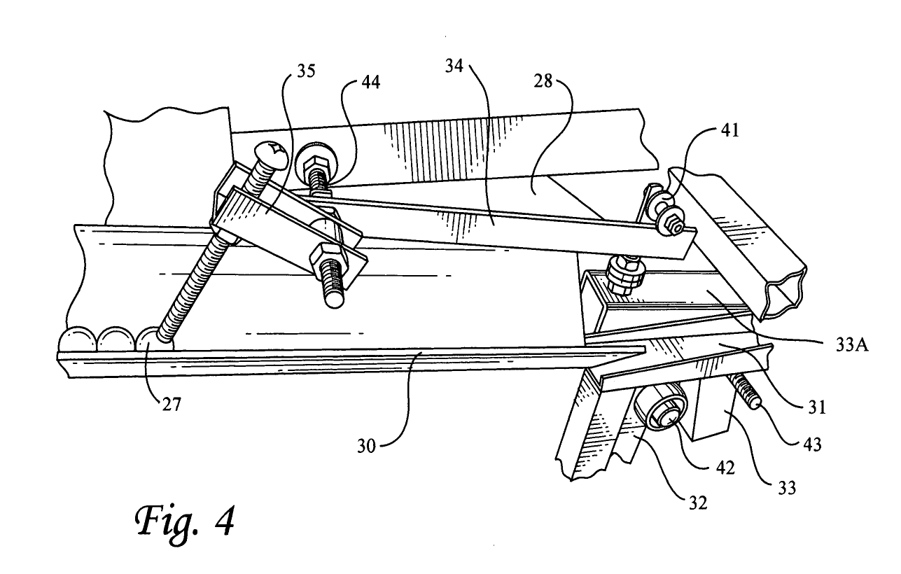

### DEFINITION OF THE NUMBERED COMPONENTS

24-frame
25-upper reservoir
26-lower reservoir
27-metal balls
30-receiving container
28-upper platform
29-lower platform
31-upper conduit
37-lower conduit
36-beveled ramp
38-directional conduit, upper platform
38A-directional conduit, lower platform
32-primary lever
33-secondary lever
33A-secondary lever
34-release lever
35-hold-and-release mechanism
39-pivot for the primary lever 32
40-guide opening for the metal balls
41-wheel on the primary lever
42-wheel on the secondary lever
43-common shaft for levers 33 and 33A
44-common shaft for release lever 34 and for hold-and-release mechanism 35

### DESCRIPTION OF THE PREFERRED EMBODIMENT

The metal balls 27 are stored in the upper reservoir 25. Under the force of gravity, the metal balls roll from the upper reservoir 25 into the receiving container 30. The hold-and-release mechanism 35 releases a single metal ball 27 from the receiving container 30. Metal ball 27 rolls onto the upper conduit 31. Metal ball 27 then rolls onto the directional conduit 38. Metal ball 27 then rolls onto the upper platform 28. On the upper platform 28, metal ball 27 rolls onto a plurality of beveled ramps 36. Controlled by the beveled ramps 36, metal ball 27 rolls from side to side on the upper platform 28. At the lowest level on the upper platform 28, metal ball 27 is guided through the guide opening 40 onto the lower platform 29. Controlled by the beveled ramps 36 on the lower platform 29, metal ball 27 then rolls onto the directional conduit 38A. Metal ball 27 then rolls onto the lower conduit 37. The lower conduit 37 has sufficient angle and length so that gravity increases the speed and inertia of metal ball 27. Metal ball 27 then makes contact with the primary lever 32. Primary lever 32 is on pivot 39. Upon making contact with primary lever 32, metal ball 27 is deposited in the lower reservoir 26. The reservoirs, platforms, conduits, and levers are supported in frame 24. Wheel 41 on the primary lever 32 makes contact with secondary lever 33. Secondary lever 33 and 33A are affixed to common shaft 43 and said levers function as a single unit. Wheel 42 on lever 33A makes contact with release lever 34. Release lever 34 and the hold-and-release mechanism 35 are affixed to common shaft 44, and the release lever and the hold-and-release mechanism function as a single unit. The hold-and-release lever 35 releases another metal ball 27, and the sequence just described is repeated.

The storage system must have sufficient capacity to prevent the upper reservoir from running out of metal balls. The upper and lower platforms and the plurality of beveled ramps predetermine the length of time a single ball is in motion. The amount of time a single ball is in motion predetermines the quantity of metal balls to be stored in the upper reservoir.

I claim:

1. A mechanical energy storage system comprising:
a) a structure having stacked reservoirs and said reservoirs are inclined
b) a top reservoir
c) a bottom reservoir
d) said top reservoir contains movable objects
e) a receiving area such that said area is adjacent to said top reservoir and said area is lower than said top reservoir and said area is inclined
f) a mechanism for selectively holding and releasing said movable objects and said mechanism is mounted in said receiving area
g) a conduit for directing said movable objects and said conduit is inclined to move said movable objects downwardly
h) a flat surface and said surface is inclined
i) a plurality of ramps sequentially mounted on said flat surface and said ramps are inclined
j) said ramps direct said movable objects
k) a secondary conduit for directing said movable objects downwardly
l) a lever pivotally mounted on said structure
m) said secondary conduit directs said movable objects downwardly and said objects make contact with said lever
n) said lever makes contact with said mechanism for selectively releasing said movable objects
o) said secondary conduit directs said movable objects into said bottom reservoir.

2. The mechanical energy storage system as recited in claim 1, wherein said movable objects are metal balls.

3. The mechanical energy storage system as recited in claim 1, wherein the force of gravity causes said downward movement of said movable objects.

4. The mechanical energy storage system as recited in claim 1, wherein said receiving area is V-shaped.

5. The mechanical energy storage system as recited in claim 4, wherein said V-shape urges said movable objects into single file.

6. The mechanical energy storage system as recited in claim 1, wherein said movable objects stored in said top reservoir have potential energy.

7. The mechanical energy storage system as recited in claim 6, wherein said potential energy stored in said movable objects is converted to kinetic energy.

8. The mechanical energy storage system as recited in claim 7, wherein said kinetic energy has sufficient gravitational force to engage said lever and said mechanism for selectively releasing said movable objects from said receiving area.

9. The mechanical energy storage system as recited in claim 1, wherein said flat surface and said ramps keep said movable objects in motion for a predetermined period of time.

10. The mechanical energy storage system as recited in claim 9, wherein said predetermined period of time influences the quantity of said movable objects to be stored in said top reservoir.

11. The mechanical energy storage system as recited in claim 10, wherein said quantity of said movable objects stored in said top reservoir predetermines the length of time that the mechanical energy storage system will keep said movable objects in continuous operation.

12. The mechanical energy storage system as recited in claim 1, wherein said movable objects directed into said bottom reservoir collectively have potential energy that can be converted to kinetic energy.

13. The mechanical energy storage system as recited in claim 1, wherein said storage system is completely independent of a backup power supply.
